(19) United States
(12) Patent Application Publication
(10) Pub. No.: US 2025/0149618 A1
(43) Pub. Date: May 8, 2025

(54) APPARATUS FOR WINDING SEPARATOR

(71) Applicant: SK ON CO., LTD., Seoul (KR)

(72) Inventors: Ji Won YANG, Daejeon (KR); Young Rae OH, Daejeon (KR); Jae Young JUNG, Daejeon (KR)

(21) Appl. No.: 18/935,049

(22) Filed: Nov. 1, 2024

(30) Foreign Application Priority Data
Nov. 3, 2023 (KR) 10-2023-0150907

(51) Int. Cl. H01M 10/04; B65H 18/10

(52) U.S. Cl. CPC H01M 10/0409; B65H 18/10

(57) ABSTRACT

An apparatus for winding a separator, including a first moving portion provided to move on a guide member; a frame provided on the first moving portion; a second moving portion provided on the frame; and a separator winding portion winding the separator, of which at least a portion is fixed to the second moving portion, around an electrode-assembly intermediate, wherein the separator winding portion holds the electrode-assembly intermediate, and lifts or lowers the electrode-assembly intermediate while rotating the electrode-assembly intermediate, is disclosed.

### CROSS-REFERENCE TO RELATED APPLICATIONS

This patent document claims the priority and benefits of Korean Patent Application No. 10-2023-0150907 filed on Nov. 3, 2023, the disclosure of which is incorporated herein by reference in its entirety.

### TECHNICAL FIELD

The technology and implementations disclosed in this patent document generally relate to an apparatus for winding a separator within a battery.

### BACKGROUND

Generally, a secondary battery is a battery that may be used repeatedly through processes of discharging that converts chemical energy into electrical energy, and charging in a reverse direction, and types thereof may include a nickel-cadmium (Ni—Cd) battery, a nickel-metal hydride (Ni-MH) battery, a lithium-metal battery, a lithium-ion (Li-Ion) battery, a lithium-ion polymer battery (Li-Ion Polymer Battery, hereinafter referred to as “LIPB”), or the like.

A secondary battery may include a positive electrode, a negative electrode, an electrolyte, and a separator, and may store and generate electricity by utilizing a difference in voltage levels between a positive electrode plate material and a negative electrode plate material, different from each other. In this case, the discharging means moving electrons from a negative electrode having a high voltage to a positive electrode having a low voltage (generating electricity equivalent to a difference in voltage with the positive electrodes), and the charging means moving electrons back from the positive electrode to the negative electrode, and in this case, a positive electrode material may receive the electrons and lithium ions, and may return to an original metal oxide thereof. That is, when the secondary battery is charged, metal atoms may move from the positive electrode to the negative electrode through the separator, causing a charging current to flow, and conversely, when the secondary battery is discharged, the metal atoms move from the negative electrode to the positive electrode, causing a discharging current to flow.

Meanwhile, when manufacturing such a secondary battery, an electrode assembly may be manufactured by alternately stacking a positive electrode plate and a negative electrode plate, cut to have a certain size, and at this time, the separator may be disposed between the positive electrode plate and the negative electrode plate. Finally, when the stacking of the positive electrode plate and the negative electrode plate is completed, the separator may be wrapped around an electrode-assembly intermediate, and then the wrapped separator may be bonded and cut.

However, during a process of wrapping the separator around the electrode-assembly intermediate, an amount of tension applied to the separator may not be constant, causing the separator to be permanently deformed. In addition, since the tension applied to the separator is not constant, there may be a problem that external force applied to the electrode-assembly intermediate may be excessively large.

### SUMMARY

An embodiment of the present disclosure provides an apparatus for winding a separator of a battery for manufacturing of the battery, capable of preventing permanent deformation of the separator.

In addition, an embodiment of the present disclosure provides an apparatus for winding a separator, capable of reducing external force applied to an electrode assembly.

In some embodiments of the disclosed technology, an apparatus for winding a separator, includes a first moving portion provided to move on a guide member; a frame provided on the first moving portion; a second moving portion provided on the frame; and a separator winding portion winding the separator, of which at least a portion is fixed to the second moving portion, around an electrode-assembly intermediate, wherein the separator winding portion holds the electrode-assembly intermediate, and lifts or lowers the electrode-assembly intermediate while rotating the electrode-assembly intermediate.

The first moving portion may include a first moving member provided to move on the guide member, and a first driver connected to the first moving member and transmitting driving force for moving the first moving member.

The first driver may include a linear motor.

The frame may include a base portion fixed to the first moving portion, and a side wall portion extending from the base portion in an upward direction.

The base portion may have a plate shape.

The side wall portion may be disposed on one end portion of the base portion.

The second moving portion may include a cylinder fixed to the frame, and an installation stand connected to the cylinder and moving on the frame.

The apparatus may further include a clamping member disposed at one side of the installation stand and fixing at least a portion of the separator.

The clamping member may be disposed on an extension portion extending from the one side of the installation stand.

A speed of the first moving portion in a section in which the first moving portion moves may be faster than a speed of the installation stand in a section in which the installation stand moves by the cylinder.

An amount of tension applied to the separator in the section in which the first moving portion moves may be less than an amount of tension applied to the separator in the section in which the installation stand moves.

A rotation speed of the electrode-assembly intermediate in the section in which the first moving portion moves may be faster than a rotation speed of the electrode-assembly intermediate in the section in which the installation stand moves.

An angle between a horizontal line passing through a point at which the separator is fixed by the clamping member and the separator may be within 5°.

In some embodiments of the disclosed technology, an apparatus for winding a separator, includes a first moving portion provided to move on a guide member; a frame provided on the first moving portion; a second moving portion provided on the frame; and a separator winding portion winding the separator, of which at least a portion is fixed to the second moving portion, around an electrode-assembly intermediate, wherein the second moving portion includes a cylinder fixed to the frame, and an installation stand connected to the cylinder and provided to move on the frame, and a speed of the first moving portion in a section in which the first moving portion moves is faster than a speed of the installation stand in a section in which the installation stand moves by the cylinder.

In some embodiments of the disclosed technology, an apparatus for winding a separator, includes a first moving portion provided to move on a guide member; a frame provided on the first moving portion; a second moving portion provided on the frame; and a separator winding portion winding the separator, of which at least a portion is fixed to the second moving portion, around an electrode-assembly intermediate, wherein the separator winding portion includes a gripper gripping the electrode-assembly intermediate; a rotary driver connected to the gripper; and a lifting driver connected to the rotary driver.

The rotary driver may include a rotary shaft connected to the gripper; and a motor connected to the rotary shaft.

### BRIEF DESCRIPTION OF DRAWINGS

Certain aspects, features, and advantages of the disclosed technology may be illustrated by the following detailed description with reference to the accompanying drawings.

FIG. 1 is a configuration diagram illustrating an apparatus for winding a separator according to an embodiment of the present disclosure.

FIGS. 2 to 11 are explanatory diagrams illustrating an operation of winding a separator around an electrode-assembly intermediate by an apparatus for winding the separator, according to an embodiment of the present disclosure.

### DETAILED DESCRIPTION

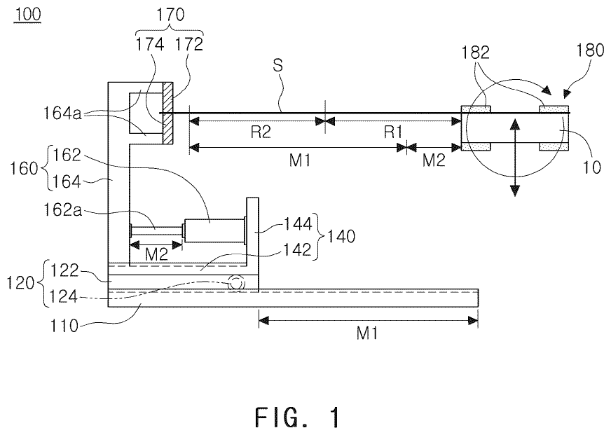

FIG. 1 is a configuration diagram illustrating an apparatus for winding a separator of a battery according to an embodiment of the present disclosure.

Referring to FIG. 1, an apparatus 100 for winding a separator according to an embodiment of the present disclosure may include a first moving portion 120, a frame 140, a second moving portion 160, and a separator winding portion 180.

The first moving portion 120 may be movably installed on a guide member 110. As an example, the guide member 110 may be configured as an LM guide installed on an apparatus body (not illustrated). The first moving portion 120 may include, as an example, a first moving member 122 moving along the guide member 110, first driver 124 transmitting driving force of the first moving member 122. In addition, the first driver 124 may include a linear motor generating driving force for moving the moving member 122.

The frame 140 may be fixedly installed to the moving member 122 of the first moving portion 120. Therefore, the frame 140 may move together with the moving member 122. As an example, the second moving portion 160 may be installed on the frame 140. In addition, the frame 140 may include a base portion 142 having a plate shape, and a side wall portion 144 extending from the base portion 142 in an upward direction.

The second moving portion 160 may be installed on the frame 140. As an example, the second moving portion 160 may be provided with a pneumatic cylinder 162 fixedly installed on the side wall portion 144 of the frame 140, and an installation stand 164 connected to a piston 162a of the pneumatic cylinder 162. The installation stand 164 may be movably installed on the base portion 142 of the frame 140. As an example, the base portion 142 of the frame 140 may be provided with a guide (not illustrated) guiding movement of the installation stand 164. The guide may be configured as a groove or an LM guide. In addition, an extension portion 164a on which a clamping member 170 is installed may be provided on one end of the installation stand 164. The clamping member 170 may be disposed on an end of the extension portion 164a. The clamping member 170 may be provided with a first clamping member 172 for fixing a separator S, and a second clamping member 174 for fixing the separator S together with the first clamping member 172.

The pneumatic cylinder 162 of the second moving portion 160 may move the installation stand 164, after movement of the first moving member 122 by the first driver 124 is completed.

In this case, a section in which the first moving member 122 moves by the first driver 124 may be defined as a first section M1, and a section in which the installation stand 164 moves by the pneumatic cylinder 162 may be defined as a second section M2.

The separator winding portion 180 may perform a function of lifting and lowering an electrode-assembly intermediate 10 while rotating the same such that the separator S is wound around an electrode-assembly intermediate 10. The separator winding portion 180 may be provided with a gripper 182 for gripping the electrode-assembly intermediate 10. The gripper 182 may hold the electrode-assembly intermediate 10 such that the electrode-assembly intermediate 10 may be lowered or lifted while rotating the same such that the separator S may be wound around the electrode-assembly intermediate 10. For example, when the electrode-assembly intermediate 10 is lowered while rotating the same by the separator winding portion 180, when the first moving member 122 of the first moving portion 120 moves toward the electrode-assembly intermediate 10, the separator S may be wound around the electrode-assembly intermediate 10. In addition, since the electrode-assembly intermediate 10 may be lowered while rotating the same by the separator winding portion 180, an amount of tension applied to the separator S may be reduced.

To this end, the separator winding portion 180 may include a rotation driver (not illustrated) for rotating the electrode-assembly intermediate 10, and an elevation driver (not illustrated) for elevating the electrode-assembly intermediate 10. As an example, the rotation driver may be provided with a rotary shaft (not illustrated) connected to the gripper 182 to rotate the gripper 182, and a motor (not illustrated) connected to the rotary shaft, and the elevation driver may be provided with an elevation cylinder (not illustrated) connected to the rotary shaft to elevate the rotary shaft and elevate the electrode-assembly intermediate 10. The rotation driver and the elevation driver are not limited to the above-described configurations, and may be changed to any configuration that may elevate and rotate the electrode-assembly intermediate 10.

Driving force for movement of the first moving member 122 in the first section M1 may be less than driving force for movement of the installation stand 164 in the second section M2. Therefore, an amount of tension applied to the separator S may be relatively smaller in the first section M1 than in the second section M2. Conversely, a rotation speed of the electrode-assembly intermediate 10 in the first section M1 may be faster than a rotation speed of the electrode-assembly intermediate 10 in the second section M2. To this end, a movement speed of the first moving member 122 provided in the first moving portion 120 in the section M1 in which the first moving portion 120 moves may be greater than a movement speed of the installation stand 164 in the section M2 in which the installation stand 164 moves by the pneumatic cylinder 162.

The electrode-assembly intermediate 10 may rotate in a first rotation section R1 rotating 180° from 0° to 180° and in a second rotation section R2 rotating 180° from 180° to 360°. In addition, while rotating 360° in the first and second rotation sections R1 and R2, a period in time for winding the separator S may be shortened by quickly rotating 180° in the first section M1. To this end, an amount of tension applied to the separator S may be weakened to reduce elongation of the separator S. In addition, in the second section M2, the separator S may be wound around the electrode-assembly intermediate 10 with a relatively strong pressure, as compared to the first section M1, thereby ensuring that the separator S may be wound around the electrode-assembly intermediate 10 without any gaps.

As described above, the separator winding portion 180 may be lowered or lifted while rotating the same such that the separator S may be wound around the electrode-assembly intermediate 10, thereby reducing an amount of tension applied to the separator S and preventing occurrence of wrinkles from forming on the separator S. In this manner, an amount of tension applied to the separator S may be reduced to reduce an external force applied to the electrode-assembly intermediate 10.

Hereinafter, an operation of an apparatus for winding a separator will be described with reference to the drawings.

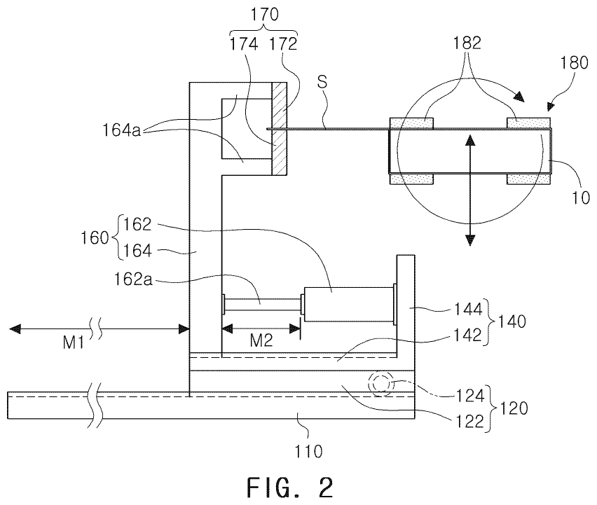

FIGS. 2 to 11 are explanatory diagrams illustrating an operation of winding a separator around an electrode-assembly intermediate by an apparatus for winding the separator, according to an embodiment of the present disclosure.

Referring to FIG. 2, a first moving member 122 of a first moving portion 120 moves along a guide member 110 installed on an apparatus body (not illustrated). In this case, when an electrode-assembly intermediate 10 rotates while being lowered or lifted by a separator winding portion 180, a separator S of which one end is fixed to a clamping member 170 of a second moving portion 160 may be wound around the electrode-assembly intermediate 10.

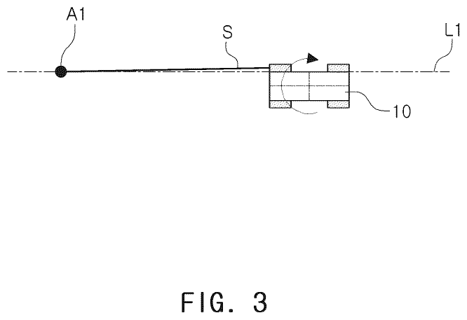

Referring thereto in more detail, when the separator S is not wound around the electrode-assembly intermediate 10, as illustrated in FIG. 3, the separator S may be located to coincide with a horizontal line L1 passing through a point A1 fixed to the clamping member 170 (see FIG. 2).

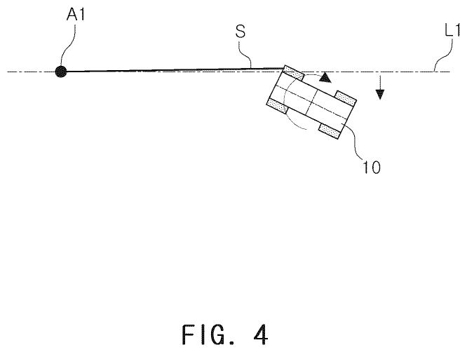

Thereafter, as illustrated in FIG. 4, the electrode-assembly intermediate 10 may begin to rotate by the separator winding portion 180, and may be lowered. In this manner, when the electrode-assembly intermediate 10 is lowered while rotating by the separator winding portion 180, the separator S may be located to approximately coincide with the horizontal line L1 passing through the point A1 fixed to the clamping member 170 (see FIG. 2). As an example, an angle between the horizontal line L1 and the separator S based on the point A1 fixed to the clamping member 170 (see FIG. 2) may be approximately within 5° (degrees). Therefore, an amount of tension applied to the separator S may be constant, and the tension applied to the separator S may be reduced, as compared to a conventional method. For example, in the conventional method, an electrode-assembly intermediate 10 simply rotated such that a separator S was wound around the electrode-assembly intermediate 10, but in this case, an angle between the horizontal line L1 passing through the point A1 fixed to the clamping member 170 of the separator S and the separator S gradually increased, such that an amount of tension applied to the separator S gradually increased. However, when the electrode-assembly intermediate 10 is lowered while rotating by the separator winding portion 180, the separator S may be disposed to be approximately aligned with the horizontal line L1 passing through the fixed point A1 of the clamping member 170 (see FIG. 2), such that an amount of tension applied to the separator S may be constant.

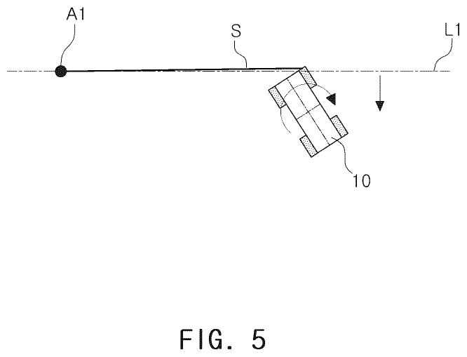

Thereafter, as illustrated in FIG. 5, the electrode-assembly intermediate 10 may continue to rotate by the separator winding portion 180, and may be continuously lowered. In this manner, when the electrode-assembly intermediate 10 is lowered while rotating by the separator winding portion 180, the separator S may be disposed to be approximately aligned with the horizontal line L1 passing through the point A1 fixed to the clamping member 170 (see FIG. 2).

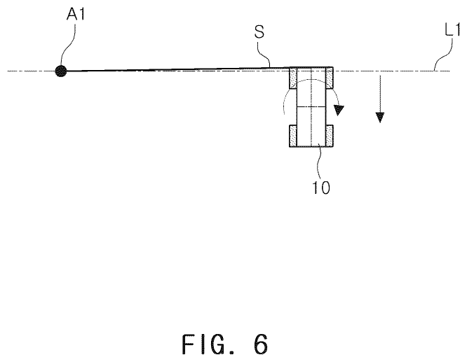

Thereafter, as illustrated in FIG. 6, when the electrode-assembly intermediate 10 rotates 90°, the electrode-assembly intermediate 10 may continue to be lowered while continuing to rotate by the separator winding portion 180. Therefore, the separator S may be disposed to be approximately aligned with the horizontal line L1 passing through the point A1 fixed to the clamping member 170 (see FIG. 2).

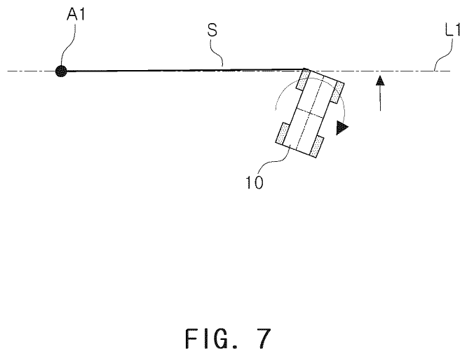

Thereafter, as illustrated in FIG. 7, when the electrode-assembly intermediate 10 continuously rotates, the electrode-assembly intermediate 10 may be lifted, as compared to a state in which the electrode-assembly intermediate 10 rotates 90°. Therefore, the separator S may be disposed to approximately coincide with the horizontal line L1 passing through the point A1 fixed to the clamping member 170 (see FIG. 2).

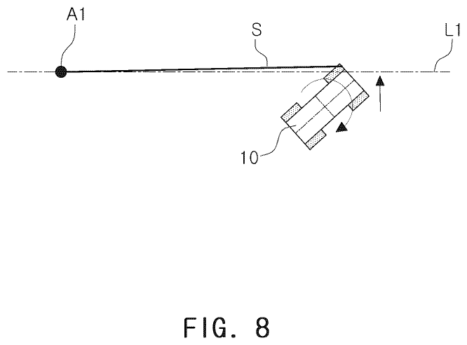

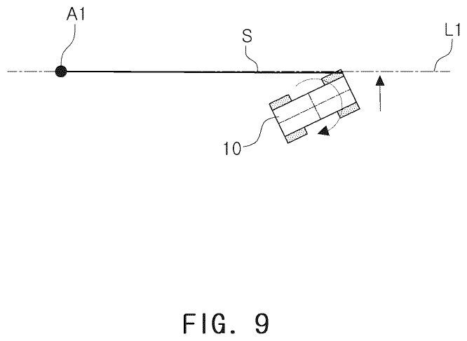

Thereafter, as illustrated in FIGS. 8 and 9, since the electrode-assembly intermediate 10 continues to be lifted while rotating, the separator S may be disposed to approximately coincide with the horizontal line L1 passing through the point A1 fixed to the clamping member 170 (see FIG. 2).

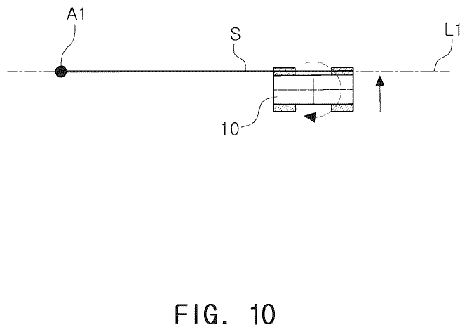

Thereafter, as illustrated in FIG. 10, the electrode-assembly intermediate 10 may continue to be lifted while continuing to rotate by the separator winding portion 180 until the electrode-assembly intermediate 10 rotates 180°. The separator S may be disposed to approximately coincide with the horizontal line L1 passing through the point A1 fixed to the clamping member 170 (see FIG. 2).

Thereafter, as illustrated in FIGS. 3 to 8, the electrode-assembly intermediate 10 may continue to be lifted while rotating. In this case, the first moving member 122 of the first moving portion 120 may move along the guide member 110 installed on the apparatus body.

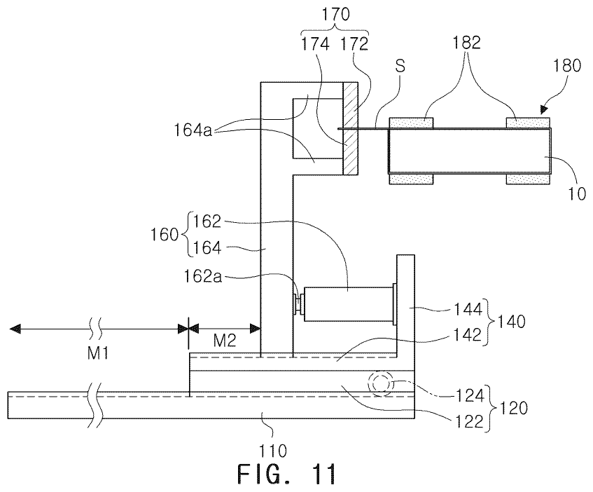

Thereafter, as illustrated in FIG. 11, while an installation stand 164 of the second moving portion 160 moves by the pneumatic cylinder 162 of the second moving portion 160, and the electrode-assembly intermediate 10 may be lifted while continuing to rotate by the separator winding portion 180. Then, in a state illustrated in FIG. 11, the electrode-assembly intermediate 10 may rotate 360°, as compared to a state illustrated in FIG. 3.

As described above, the separator winding portion 180 may be lowered or lifted while rotating the same such that the separator S may be wound around the electrode-assembly intermediate 10, thereby reducing an amount of tension applied to the separator S and preventing occurrence of wrinkles from forming on the separator S. In this manner, an amount of tension applied to the separator S may be reduced to reduce an external force applied to the electrode-assembly intermediate 10.

Although various embodiments of the present disclosure have been described in detail above, it will be self-evident to a person having average knowledge in the relevant technical field that the scope of the present disclosure is not limited thereto, and various modifications and variations are possible without departing from the technical spirit of the present disclosure as set forth in the claims. Additionally, the above-described embodiments may be implemented by deleting some components, and each embodiment may be implemented in combination with each other.

An embodiment of the present disclosure may have an effect of preventing permanent deformation of a separator.

In addition, an embodiment of the present disclosure may have an effect of reducing an external force applied to an electrode assembly.

The disclosed technology can be implemented for manufacturing rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to manufacture improved electrochemical devices such as a battery used in various power sources and power supplies, thereby mitigating climate changes in connection with uses of power sources and power supplies. The secondary batteries made by using the disclosed technology can be used to address various adverse effects such as air pollution and greenhouse emissions by powering electric vehicles (EVs) as alternatives to vehicles using fossil fuel-based engines and by providing battery-based energy storage systems (ESSs). Such secondary batteries may include, for example, lithium ion batteries, nickel-cadmium batteries, nickel-metal hydride batteries, and nickel-hydrogen batteries.

Only specific examples of implementations of certain embodiments are described. Variations, improvements and enhancements of the disclosed embodiments and other embodiments may be made based on the present disclosure.

What is claimed is:

1. An apparatus for winding a separator of a battery for manufacturing the battery, comprising:
a first moving portion provided to move on a guide member;
a frame provided on the first moving portion;
a second moving portion provided on the frame; and
a separator winding portion winding the separator, of which at least a portion is fixed to the second moving portion, around an electrode-assembly intermediate,
wherein the separator winding portion holds the electrode-assembly intermediate, and lifts or lowers the electrode-assembly intermediate while rotating the electrode-assembly intermediate.

2. The apparatus of claim 1, wherein the first moving portion comprises a first moving member provided to move on the guide member, and a first driver connected to the first moving member and transmitting driving force for moving the first moving member.

3. The apparatus of claim 2, wherein the first driver comprises a linear motor.

4. The apparatus of claim 1, wherein the frame comprises a base portion fixed to the first moving portion, and a side wall portion extending from the base portion in an upward direction.

5. The apparatus of claim 4, wherein the base portion has a plate shape.

6. The apparatus of claim 5, wherein the side wall portion is disposed on one end portion of the base portion.

7. The apparatus of claim 1, wherein the second moving portion comprises a cylinder fixed to the frame, and an installation stand connected to the cylinder and moving on the frame.

8. The apparatus of claim 7, further comprising a clamping member disposed at one side of the installation stand and fixing at least a portion of the separator.

9. The apparatus of claim 8, wherein the clamping member is disposed on an extension portion extending from the one side of the installation stand.

10. The apparatus of claim 7, wherein a speed of the first moving portion in a section in which the first moving portion moves is faster than a speed of the installation stand in a section in which the installation stand moves by the cylinder.

11. The apparatus of claim 10, wherein an amount of tension applied to the separator in the section in which the first moving portion moves is less than an amount of tension applied to the separator in the section in which the installation stand moves.

12. The apparatus of claim 10, wherein a rotation speed of the electrode-assembly intermediate in the section in which the first moving portion moves is faster than a rotation speed of the electrode-assembly intermediate in the section in which the installation stand moves.

13. The apparatus of claim 8, wherein an angle between a horizontal line passing through a point at which the separator is fixed by the clamping member and the separator is within 5°.

14. An apparatus for winding a separator of a battery for manufacturing the battery, comprising:
a first moving portion provided to move on a guide member;
a frame provided on the first moving portion;
a second moving portion provided on the frame; and
a separator winding portion winding the separator, of which at least a portion is fixed to the second moving portion, around an electrode-assembly intermediate,
wherein the second moving portion includes a cylinder fixed to the frame, and an installation stand connected to the cylinder and provided to move on the frame, and
a speed of the first moving portion in a section in which the first moving portion moves is faster than a speed of the installation stand in a section which the installation stand moves by the cylinder.

15. An apparatus for winding a separator of a battery for manufacturing the battery, comprising:
a first moving portion provided to move on a guide member;
a frame provided on the first moving portion;
a second moving portion provided on the frame; and
a separator winding portion winding the separator, of which at least a portion is fixed to the second moving portion, around an electrode-assembly intermediate,
wherein the separator winding portion includes:
a gripper gripping the electrode-assembly intermediate;
a rotary driver connected to the gripper; and
a lifting driver connected to the rotary driver.

16. The apparatus of claim 15, wherein the rotary driver comprises:
a rotary shaft connected to the gripper; and
a motor connected to the rotary shaft.
